(19) United States
(12) Patent Application Publication
(10) Pub. No.: US 2023/0365772 A1
(43) Pub. Date: Nov. 16, 2023

(54) A PROCESS FOR THE PRODUCTION OF A MOULDED ARTICLE

(71) Applicant: BASF SE, Ludwigshafen am Rhein (DE)

(72) Inventor: Philippe DESBOIS, Ludwigshafen (DE)

(21) Appl. No.: 18/246,957

(22) PCT Filed: Sep. 29, 2021
(86) PCT No.: PCT/EP2021/076782

§ 371 Date: Mar. 28, 2023

(30) Foreign Application Priority Data
Sep. 30, 2020 (EP) 20199248.4

(51) Int. Cl. C08J 9/00; C08J 9/12; C08J 9/08; C08K 7/20; C08K 3/04; B29C 45/00; B29C 45/17; B29C 44/34

(52) U.S. Cl. CPC C08J 9/0085; C08J 9/0066; C08J 9/122; C08J 9/08; C08K 7/20; C08K 3/04; B29C 45/0001; B29C 45/1706; B29C 45/0005; B29C 44/3446; B29C 45/0025; C08J 2377/02; C08J 2203/06; C08J 2203/02; B29K 2105/04

(57) ABSTRACT

Disclosed herein is a process for the production of a moulded article (MA). Additionally disclosed herein is a method of using at least one blowing gas (C) in the production of a moulded article (MA) for reducing the warpage of the moulded article (MA), where the moulded article (MA) includes at least one thermoplastic polymer (A) and at least one reinforcing fibre (B). Further disclosed herein is the moulded article (MA) obtained by the process.

The present invention relates to a process for the production of a moulded article (MA) comprising the following steps a) to d). In step a), a flowable composition (FC) comprising at least one thermoplastic polymer (A), at least one reinforcing fibre (B) and at least one blowing gas (C) is provided. In step b), the flowable composition (FC) provided in step a) is injected into a mould at a first pressure (p₁). In step c), the flowable composition (FC) injected in step b) is cooled at a holding pressure (p₂), wherein the holding pressure (p₂) is lower than the first pressure (p₁), to obtain the moulded article (MA). In step d), the moulded article (MA) is removed from the mould. The present invention further relates to the use of at least one blowing gas (C) in the production of a moulded article (MA) for reducing the warpage of the moulded article (MA), wherein the moulded article (MA) comprises at least one thermoplastic polymer (A) and at least one reinforcing fibre (B). In addition, the present invention also relates to the moulded article (MA) obtained by the inventive process.

Thermoplastic polymers, especially semicrystalline thermoplastic polymers, in general are polymers which are of particular importance industrially on account of their very good mechanical properties. In particular, they possess high strength, stiffness, and toughness, good chemical resistance, and a high abrasion resistance and tracking resistance. These properties are particularly important for the production of injection mouldings.

However, as injected-moulded thermoplastic polymers, especially thermoplastic polymers comprising reinforcing fibres, generally show an undesired anisotropic shrinkage during cooling, which means that they shrink more in transverse direction (perpendicular shrinkage) than in longitudinal direction (parallel shrinkage), the resulting moulded articles often show an increased warpage which makes them inadequate for some applications, especially for some applications in the automotive or electronic industry.

It is therefore an object of the present invention to provide an improved process for the production of a moulded article with a reduced warpage and good mechanical properties. Further, it should be possible to produce the moulded article in a very simple and inexpensive manner.

This object is achieved in accordance with the invention by a process for the production of a moulded article (MA) comprising the following steps a) to d) of
a) providing a flowable composition (FC) comprising at least the following components (A) to (C)
   (A) at least one thermoplastic polymer,
   (B) at least one reinforcing fibre and
   (C) at least one blowing gas,
b) injecting the flowable composition (FC) provided in step a) into a mould at a first pressure (p₁),
c) cooling the flowable composition (FC) injected in step b) at a holding pressure (p₂), wherein the holding pressure (p₂) is lower than the first pressure (p₁), to obtain the moulded article (MA), and
d) removing the moulded article (MA) from the mould.

Surprisingly, it has been found that the use of at least one blowing gas (C) in the production of a moulded article (MA), comprising at least one thermoplastic polymer (A) and at least one reinforcing fibre (B), leads to a moulded article (MA) with a reduced warpage compared to moulded articles of the prior art.

During cooling, the shrinkage of the moulded article (MA) in longitudinal direction (parallel shrinkage), surprisingly, is increased, whereas the shrinkage in transverse direction (perpendicular shrinkage) changes very little.

Further, it has been found that the inventive moulded articles (MA) exhibit good mechanical properties like a high tensile modulus of elasticity and a high tensile strength.

The process for the production of the moulded article (MA) according to the invention is more particularly elucidated herein below.

### Flowable Composition (FC)

According to the invention the flowable composition (FC) comprises at least one thermoplastic polymer (A), at least one reinforcing fibre (B) and at least one blowing gas (C).

In the context of the present invention “at least one thermoplastic polymer (A)” is to be understood as meaning either precisely one thermoplastic polymer (A) or else a mixture of two or more thermoplastic polymers (A).

The same applies for “at least one reinforcing fibre (B)” and for “at least one blowing gas (C)”. In the context of the present invention “at least one reinforcing fibre (B)” is to be understood as meaning either precisely one reinforcing fibre (B) or else a mixture of two or more reinforcing fibres (B). Further, in the context of the present invention “at least one blowing gas (C)” is to be understood as meaning either precisely one blowing gas (C) or else a mixture of two or more blowing gases (C).

The flowable composition (FC) may comprise the at least one thermoplastic polymer (A), the at least one reinforcing fibre (B) and the at least one blowing agent (C) in any desired amounts.

It is preferable when the flowable composition (FC) comprises in the range from 0.01 to 10% by volume of the at least one blowing gas (C), based on the sum of the volume percentages of the at least one thermoplastic polymer (A), the at least one reinforcing fibre (B) and the at least one blowing gas (C), preferably based on the total volume of the flowable composition (FC).

It is particularly preferable when the flowable composition (FC) comprises in the range from 0.1 to 8% by volume of the at least one blowing gas (C), based on the sum of the volume percentages of the at least one thermoplastic polymer (A), the at least one reinforcing fibre (B) and the at least one blowing gas (C), preferably based on the total volume of the flowable composition (FC).

It is most preferable when the flowable composition (FC) comprises in the range from 0.5 to 5% by volume of the at least one blowing gas (C), based on the sum of the volume percentages of the at least one thermoplastic polymer (A), the at least one reinforcing fibre (B) and the at least one blowing gas (C), preferably based on the total volume of the flowable composition (FC).

The present invention thus also provides a process for the production of a moulded article (MA) in which, in step a), the flowable composition (FC) comprises in the range from 0.01 to 10% by volume of the at least one blowing gas (C), based on the total volume of the flowable composition (FC).

Consequently, the flowable composition (FC) preferably comprises in the range from 90 to 99.99% by volume of the at least one thermoplastic polymer (A) and the at least one reinforcing fibre (B), based on the sum of the volume percentages of the at least one thermoplastic polymer (A), the at least one reinforcing fibre (B) and the at least one blowing gas (C), preferably based on the total volume of the flowable composition (FC).

It is particularly preferable when the flowable composition (FC) comprises in the range from 92 to 99.9% by volume of the at least one thermoplastic polymer (A) and the at least one reinforcing fibre (B), based on the sum of the volume percentages of the at least one thermoplastic polymer (A), the at least one reinforcing fibre (B) and the at least one blowing gas (C), preferably based on the total volume of the flowable composition (FC).

It is most preferable when the flowable composition (FC) comprises in the range from 95 to 99.5% by volume of the at least one thermoplastic polymer (A) and the at least one reinforcing fibre (B), based on the sum of the volume percentages of the at least one thermoplastic polymer (A), the at least one reinforcing fibre (B) and the at least one blowing gas (C), preferably based on the total volume of the flowable composition (FC).

Further, the flowable composition (FC) preferably comprises in the range from 36 to 99.99% by weight of component (A) and in the range from 0.01 to 64% by weight of component (B), based in each case on the sum of the weight percentages of the at least one thermoplastic polymer (A) and the at least one reinforcing fibre (B).

The flowable composition (FC) more preferably comprises in the range from 47.5 to 89.99% by weight of component (A) and in the range from 10.01 to 52.5% by weight of component (B), based in each case on the sum of the weight percentages of the at least one thermoplastic polymer (A) and the at least one reinforcing fibre (B).

The flowable composition (FC) most preferably comprises in the range from 58.5 to 79.96% by weight of component (A) and in the range from 20.04 to 41.5% by weight of component (B), based in each case on the sum of the weight percentages of the at least one thermoplastic polymer (A) and the at least one reinforcing fibre (B).

The flowable composition (FC) may further comprise at least one carbon black (D) in addition to the at least one thermoplastic polymer (A), the at least one reinforcing fibre (B) and the at least one blowing gas (C).

The present invention thus also provides a process for the production of a moulded article (MA) in which the flowable composition (FC) further comprises at least one carbon black (D).

Furthermore, the flowable composition (FC) may comprise at least one further additive (E) in addition to the at least one thermoplastic polymer (A), the at least one reinforcing fibre (B), the at least one blowing gas (C) and optionally, the at least one carbon black (D).

In the context of the present invention, “at least one carbon black (D)” is to be understood as meaning either precisely one carbon black (D) or else a mixture of two or more carbon blacks (D). In the context of the present invention “at least one further additive (E)” is to be understood as meaning either precisely one further additive (E) or else a mixture of two or more further additives (E).

In case the flowable composition (FC) comprises at least one carbon black (D), the flowable composition (FC) comprises, for example, in the range from 0.01 to 5.5% by weight, preferably in the range from 0.1 to 4.5% by weight, most preferably in the range from 0.3 to 3.5% by weight, of the at least one carbon black (D), based in each case on the sum of the weight percentages of the at least one thermoplastic polymer (A), the at least one reinforcing fibre (B), the at least one carbon black (D) and, optionally, the at least one further additive (E).

In case the polymer composition (PC) comprises at least one further additive (E), the polymer composition (PC) comprises, for example, in the range from 0.1 to 2.5% by weight, preferably in the range from 0.2 to 2% by weight, most preferably in the range from 0.5 to 1.5% by weight, of the at least one further additive (E), based in each case on the sum of the weight percentages of the at least one thermoplastic polymer (A), the at least one reinforcing fibre (B), the at least one further additive (E) and, optionally, the at least one carbon black (D).

It will be appreciated that when the flowable composition (FC) comprises at least one carbon black (D) and/or at least one further additive (E), the % by weight values of the at least one thermoplastic polymer (A) present in the flowable composition (FC) are correspondingly reduced so that the sum of the % by weight values of the at least one thermoplastic polymer (A), of the at least one reinforcing fibre (B) and, optionally, of the at least one carbon black (D) and/or at least one further additive (E) sum to 100%.

### Thermoplastic Polymer (Component (A))

The flowable composition (FC) comprises at least one thermoplastic polymer (A).

Suitable thermoplastic polymers (A) are selected from the group consisting of polyamides, polyesters, polycarbonates, polyolefins, polyurethanes, polyethers, polysulfones, polymethacrylates, polystyrenes and polyoxymethylene.

Thus, the present invention also provides a process for the production of a moulded article (MA) in which the at least one thermoplastic polymer (A) is selected from the group consisting of polyamides, polyesters, polycarbonates, polyolefins, polyurethanes, polyethers, polysulfones, polymethacrylates, polystyrenes and polyoxymethylene.

Suitable polyamides (A) generally have a viscosity number of 70 to 350 ml/g, preferably of 70 to 240 ml/g. The viscosity number is determined according to the invention from a 0.5 wt % solution of the polyamide (A) in 96 wt % sulfuric acid at 25° C. according to ISO 307.

Preferred polyamides (A) are semicrystalline polyamides. Suitable polyamides (A) have a weight-average molecular weight (M_{W}) in the range from 500 to 2 000 000 g/mol, preferably in the range from 5 000 to 500 000 g/mol and particularly preferably in the range from 10 000 to 100 000 g/mol. The weight-average molecular weight (M_{w}) is determined according to ASTM D4001.

Suitable polyamides (A) include for example polyamides (A) which derive from lactams having 7 to 13 ring members. Suitable polyamides (A) further include polyamides (A) obtained by reaction of dicarboxylic acids with diamines.

Examples of polyamides (A) which derive from lactams include polyamides which derive from polycaprolactam, polycaprylolactam and/or polylaurolactam.

Suitable polyamides (A) further include those obtainable from ω-aminoalkyl nitriles. A preferred ω-aminoalkylnitrile is aminocapronitrile which results in polyamide 6. Furthermore, dinitriles may be reacted with diamine. Preference is given here to adipodinitrile and hexamethylenediamine which polymerize to afford polyamide 66. The polymerization of nitriles is effected in the presence of water and is also known as direct polymerization.

When polyamides (A) obtainable from dicarboxylic acids and diamines are used, dicarboxylic acid alkanes (aliphatic dicarboxylic acids) having 4 to 36 carbon atoms, preferably 6 to 12 carbon atoms and particularly preferably 6 to 10 carbon atoms may be employed. Aromatic dicarboxylic acids are also suitable.

Examples of dicarboxylic acids include adipic acid, azelaic acid, sebacic acid, dodecanedioic acid and also terephthalic acid and/or isophthalic acid.

Suitable diamines include for example alkanediamines having 4 to 36 carbon atoms, preferably alkanediamines having 6 to 12 carbon atoms, in particular alkanediamines having 6 to 8 carbon atoms, and aromatic diamines, for example, m-xylylenediamine, di(4-aminophenyl)methane, di(4-aminocyclohexyl)methane, 2,2-di(4-aminophenyl)-propane, 2,2-di(4-aminocyclohexyl)propane and 1,5-diamino-2-methylpentane.

Preferred polyamides (A) are polyhexamethylene adipamide, polyhexamethylene sebacamide and polycaprolactam and also copolyamide 6/66, in particular having a proportion of caprolactam units of 5 to 95 wt %.

Also suitable are polyamides (A) obtainable by copolymerization of two or more of the monomers mentioned hereinabove and hereinbelow or mixtures of a plurality of polyamides (A) in any desired mixing ratio. Particularly preferred mixtures are mixtures of polyamide 66 with other polyamides (A), in particular copolyamide 6/66.

Suitable polyamides (A) are accordingly aliphatic, semiaromatic or aromatic polyamides (A). The term “aliphatic polyamides” is to be understood as meaning that the polyamides (A) are constructed exclusively from aliphatic monomers. The term “semiaromatic polyamides” is to be understood as meaning that the polyamides (A) are constructed from both aliphatic and aromatic monomers. The term “aromatic polyamides” is to be understood as meaning that the polyamides (A) are constructed exclusively from aromatic monomers.

The no exhaustive list which follows comprises the abovementioned, and further, polyamides (A) suitable for use in the process according to the invention and the monomers present.

### AB Polymers:

| | |
|---|---|
| PA 4 | pyrrolidone |
| PA 6 | ε-caprolactam |
| PA 7 | enantholactam |
| PA 8 | caprylolactam |
| PA 9 | 9-aminopelargonic acid |
| PA 11 | 11-aminoundecanoic acid |
| PA 12 | laurolactam |

### AA/BB Polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1010 | decane-1, 12-diamine, sebacic acid |
| PA 1212 | dodecane-1, 12-diamine, decanedicarboxylic acid |
| PA 1313 | tridecane-1, 13-diamine, undecanedicarboxylic acid |
| PA 4T | tetramethylenediamine, terephthalic acid |
| PA 6T | hexamethylenediamine, terephthalic acid |
| PA 9T | nonyldiamine, terephthalic acid |
| PA MXD6 | m-xylylenediamine, adipic acid |
| PA 6I | hexamethylenediamine, isophthalic acid |
| PA 6-3-T | trimethylhexamethylenediamine, terephthalic acid |
| PA 6/6T | (see PA 6 and PA 6T) |
| PA 6/66 | (see PA 6 and PA 66) |
| PA 66/6 | (see PA 66 and PA 6) |
| PA 6/12 | (see PA 6 and PA 12) |
| PA 66/6/610 | (see PA 66, PA 6 and PA 610) |
| PA 6I/6T | (see PA 61 and PA 6T) |
| PA PACM 12 | diaminodicyclohexylmethane, laurolactam |
| PA 6I/6T/PACM | as PA 61/6T and diaminodicyclohexylmethane |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |

In a preferred embodiment, the at least one polyamide (A) is selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/6I (PA 6T/6I), polyamide 12 (PA12), polyamide 4T (PA 4T), polyamide 9T (PA 9T), polyamide 46 (PA 46), polyamide 1010 (PA1010) and polyamide 1212 (PA1212).

Thus, the present invention also provides a process for the production of a moulded article (MA) in which the at least one thermoplastic polymer (A) is selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/6I (PA 6T/6I), polyamide 12 (PA12), polyamide 4T (PA 4T), polyamide 9T (PA 9T), polyamide 46 (PA 46), polyamide 1010 (PA1010) and polyamide 1212 (PA1212).

Suitable polyesters are, for example, polybutylene terephthalate (PBT) and polyethylene terephthalate (PET). Suitable polyolefins are, for example, polypropylene (PP), high-density polyethylene (HDPE), low-density polyethylene (LDPE) and their copolymers. A suitable polyurethane is, for example, thermoplastic polyurethane (TPU). A suitable polyether is, for example, propylene oxide (PPO). Suitable polysulfones are, for example, polyether sulfone (PES), polysulfone (PSU) and polyphenylene sulfone (PPSU).

### Reinforcing Fibre (Component (B))

The flowable composition (FC) comprises at least one reinforcing fibre (B).

Suitable reinforcing fibres (B) are selected from the group consisting of natural fibres, basalt fibres, aramid fibres, glass fibres and carbon fibres, preferably from glass fibres.

Thus, the present invention also provides a process for the production of a moulded article (MA) in which the at least one reinforcing fibre (B) is selected from the group consisting of natural fibres, basalt fibres, aramid fibres, glass fibres and carbon fibres.

In a preferred embodiment, the at least one reinforcing fibre (B) is selected from glass fibres, wherein the ratio of the length of the glass fibres to the diameter of the glass fibres is in the range from 20:1 to 30:1, where the length of the glass fibres and the diameter of the glass fibres are determined by microscopy by means of image evaluation on samples after ashing, with evaluation of at least 70 000 parts of the glass fibres after ashing.

Thus, the present invention also provides a process for the production of a moulded article (MA) in which the at least one reinforcing fibre (B) is selected from glass fibres, wherein the ratio of the length of the glass fibres to the diameter of the glass fibres is in the range from 20:1 to 30:1.

### Blowing Gas (Component (C))

The flowable composition (FC) comprises at least one blowing gas (C).

In a preferred embodiment, the at least one blowing gas (C) is selected from the group consisting of nitrogen, carbon dioxide and carbon monoxide.

Thus, the present invention also provides a process for the production of a moulded article (MA) in which the at least one blowing gas (C) is selected from the group consisting of nitrogen, carbon dioxide and carbon monoxide.

In this case, the at least one blowing gas (C) is preferably obtained by decomposing at least one blowing agent (C*).

Suitable blowing agents (C*) are selected from the group consisting of gas-releasing polymers, gas-releasing additives and mixtures therefrom.

Therefore, the present invention also provides a process for the production of a moulded article (MA) in which the at least one blowing agent (C*) is selected from the group consisting of gas-releasing polymers, gas-releasing additives and mixtures therefrom.

Suitable gas-releasing polymers are polymers which are solids at room temperature and, on heating, decompose at a particular temperature, releasing a blowing gas such as nitrogen, carbon dioxide or carbon monoxide. An example for a particularly suitable gas-releasing polymer is styrene-maleic-anhydride-copolymer which can be purchased under the tradename SMA®3000 from Cray Valley.

Suitable gas-releasing additives generally are low-molecular-weight inorganic or organic compounds which are in powder or pellet form at room temperature and, on heating, decompose at a particular temperature, releasing a blowing gas such as nitrogen, carbon dioxide or carbon monoxide. Examples for inorganic gas-releasing additives are sodium bicarbonate, ammonium carbonate, ammonium bicarbonate, and calcium azide. Examples for organic gas-releasing additives are azo compounds, N-nitroso-compounds and sulphonyl hydrazides.

In another preferred embodiment, the at least one blowing gas (C) is selected from hydrocarbons. Examples for suitable hydrocarbons are iso-butane, cyclopentane and iso-pentane.

In this case, the at least one blowing gas (C) is not obtained by decomposing at least one blowing agent (C*).

The at least one blowing gas (C) is used in the production of the moulded article (MA) for reducing the warpage of the moulded article (MA).

Therefore, the present invention also provides the use of at least one blowing gas (C) in the production of a moulded article (MA) for reducing the warpage of the moulded article (MA), wherein the moulded article (MA) comprises at least one thermoplastic polymer (A) and at least one reinforcing fibre (B).

### Carbon Black (Component (D))

In one embodiment, the flowable composition (FC) further comprises at least one carbon black (D).

Therefore, the present invention also provides a process for the production of a moulded article (MA) in which the flowable composition (FC) further comprises at least one carbon black (D).

Preferably, the surface layer of the at least one carbon black (D) comprises not more than 2% by weight of oxygen, based on the total weight of the surface layer of the at least one carbon black (D), wherein the weight of oxygen in the surface layer is measured by X-ray photoelectron spectroscopy at an X-ray penetration depth of 2 to 10 nm.

The term “surface layer” is known to those skilled in the art.

In the context of the present invention the term “surface layer” is determined by the X-ray penetration depth and means the layer between the surface of the at least one carbon black (D) and a distance of 2 to 10 nm from the surface of the at least one carbon black (D).

It is more preferable when the surface layer of the at least one carbon black (D) comprises not more than 1.5% by weight of oxygen, based on the total weight of the surface layer of the at least one carbon black (D), and wherein the weight of oxygen in the surface layer is measured by X-ray photoelectron spectroscopy at an X-ray penetration depth of 2 to 10 nm.

It is most preferable when the surface layer of the at least one carbon black (D) comprises not more than 1.25% by weight of oxygen, based on the total weight of the surface layer of the at least one carbon black (D), and wherein the weight of oxygen in the surface layer is measured by X-ray photoelectron spectroscopy at an X-ray penetration depth of 2 to 10 nm.

Further, it is preferable when the surface layer of the at least one carbon black (D) comprises not more than 1% by weight of nitrogen, based on the total weight of the surface layer of component (D), and wherein the weight of nitrogen in the surface layer is measured by X-ray photoelectron spectroscopy at an X-ray penetration depth of 2 to nm.

It is more preferable when the surface layer of the at least one carbon black (D) comprises not more than 0.8% by weight of nitrogen, based on the total weight of the surface layer of component (D), and wherein the weight of nitrogen in the surface layer is measured by X-ray photoelectron spectroscopy at an X-ray penetration depth of 2 to nm.

It is most preferable when the surface layer of the at least one carbon black (D) comprises not more than 0.6% by weight of nitrogen, based on the total weight of the surface layer of component (D), and wherein the weight of nitrogen in the surface layer is measured by X-ray photoelectron spectroscopy at an X-ray penetration depth of 2 to nm.

The weight percentages of the oxygen and the nitrogen comprised in the surface layer of the at least one carbon black (D) preferably comprised in the flowable composition (FC) are determined by X-ray photoelectron spectroscopy (XPS).

X-ray photoelectron spectroscopy (XPS) is a quantitative spectroscopic technique that can measure the elemental composition, empirical formula, chemical state and electronic state of the elements that exist within a sample, in the present case a sample of the at least one carbon black (D). By irradiating the sample with a beam of X-rays while simultaneously measuring the kinetic energy and number of electrons that escape from the surface layer of the sample, XPS spectra may be obtained. In the present case, the X-ray has a penetration depth of 2 to 10 nm which means that electrons can escape from not more than 2 to 10 nm below the surface of the sample. XPS analysis commonly employs monochromatic aluminum Kot (AlKa) X-rays, which may be generated by bombarding an aluminum anode surface with a focused electron beam. A fraction of the generated AlKa X-rays is then intercepted by a focusing monochromator and a narrow X-ray energy band is focused onto the analysis site on the sample surface. The X-ray flux of the AlKa X-rays at the sample surface depends on the electron beam current, the thickness and integrity of the aluminium anode surface, and crystal quality, size, and stability of the monochromator.

Carbon blacks are known in principle to those skilled in the art.

The at least one carbon black (D) preferably comprised in the flowable composition (FC) generally has a low sieve residue, a low volume resistivity and a low pour density.

In a preferred embodiment, the at least one carbon black (D) has a 325-mesh sieve residue of less than 50 ppm, preferably of less than 20 ppm and more preferably of less than 10 ppm. The sieve residue is determined according to ASTM D1514-00.

Further, the at least one carbon black (D) preferably has a volume resistivity of less than 100 Ω*cm, more preferably of less than 50 Ω*cm and most preferably of less than 20 Ω*cm.

The at least one carbon black (D) has preferably a pour density of less than 300 g/L and more preferably of less than 200 g/L. The pour density is determined according to ASTM D1513-99.

The at least one carbon black (D) may be present in any desired form. It is preferable when component (D) is present in the form of a powder. It is especially preferable when component (D) is present as powder having an average particle size (D50 value) in the range from 5 to 70 nm, more preferably in the range from 10 to 60 nm and most preferably in the range from 15 to 50 nm.

In the context of the present invention “D50 value” is to be understood as meaning the particle size at which 50 vol % of the particles based on the total volume of the particles are smaller than or equal to the D50 value and 50 vol % of the particles based on the total volume of the particles are larger than the D50 value.

Suitable carbon blacks are, for example, partial combustion carbon blacks.

Partial combustion carbon blacks preferably have a partially graphitic structure and are preferably produced by a process based on partial oil oxidation of carbochemical and petrochemical origin with a low velocity, no quench and no additives.

### Further Additive (Component (E))

In one embodiment, the flowable composition (FC) also comprises at least one further additive (E).

Suitable further additives (E) are known per se to those skilled in the art. The further additives (E) are preferably selected from the group consisting of stabilizers, dyes, pigments, impact modifiers, flame retardants and plasticizers.

Thus, the present invention also provides a process for the production of a moulded article (MA) in which the flowable composition (FC) comprises at least one further additive (E) selected from the group consisting of stabilizers, dyes, pigments, impact modifiers, flame retardants and plasticizers.

Suitable stabilizers are, for example, phenol, talc, alkaline earth metal silicates, sterically hindered phenols, phosphites and alkaline earth metal glycerophosphates.

Suitable dyes and pigments are, for example, transition metal oxides or nigrosins.

Suitable impact modifiers are, for example, polymers based on ethylene propylene (EPM) or ethylene propylene diene (EPDM) rubbers or thermoplastic urethanes and also ionomers or styrene-based rubbers.

Suitable flame retardants are, for example, melamine cyanurate, aluminium derivatives, magnesium derivatives and halogenides.

Suitable plasticizers are, for example, dioctyl phthalate, dibenzyl phthalate, butyl benzyl phthalate, hydrocarbon oils, N-(n-butyl)-benzenesulfonamide and ortho- and para-tolylethylsulfonamide.

### Provision of the Flowable Composition (FC) (Step a))

In step a), a flowable composition (FC) comprising at least the following components (A) to (C)
(A) at least one thermoplastic polymer,
(B) at least one reinforcing fibre and
(C) at least one blowing gas
   is provided.

The flowable composition (FC) may be provided by any method known to those skilled in the art.

Preferably, it is provided by compounding.

Processes for compounding are known to those skilled in the art.

For example, the at least one thermoplastic polymer (A), the at least one reinforcing fibre (B), the at least one blowing gas (C) and optionally the at least one carbon black (D) and/or the at least one further additive (E) may be compounded in an extruder.

Thus, the present invention also provides a process for the production of a moulded article (MA) in which the flowable composition (FC) is provided by compounding at least the following components (A) to (C):
(A) at least one thermoplastic polymer,
(B) at least one reinforcing fibre and
(C) at least one blowing gas,
   in an extruder to obtain the flowable composition (FC) comprising at least the components (A) to (C).

In a preferred embodiment, the at least one blowing gas (C) is obtained by decomposing at least one blowing agent (C*).

In this case, the flowable composition (FC) is provided by compounding a polymer composition (PC) comprising at least the following components (A), (B) and (C*)
(A) at least one thermoplastic polymer,
(B) at least one reinforcing fibre and
(C*) at least one blowing agent,
   in an extruder, wherein the at least one blowing agent (C*) is decomposed to obtain the at least one blowing gas (C), to obtain the flowable composition (FC) comprising at least the components (A) to (C).

Therefore, the present invention also provides a process for the production of a moulded article (MA) in which the flowable composition (FC) is provided by compounding a polymer composition (PC) comprising at least the following components (A), (B) and (C*)
(A) at least one thermoplastic polymer,
(B) at least one reinforcing fibre and
(C*) at least one blowing agent,
   in an extruder, wherein the at least one blowing agent (C*) is decomposed to obtain the at least one blowing gas (C), to obtain the flowable composition (FC) comprising at least the components (A) to (C).

In this case, it is preferable when the polymer composition (PC) comprises in the range from 35 to 99.98% by weight of the at least one thermoplastic polymer (A), from 0.01 to 60% by weight of the at least one reinforcing fibre (B) and in the range from 0.01 to 5% by weight of the at least one blowing agent (C*), in each case based on the sum of the weight percentages of the at least one thermoplastic polymer (A), the at least one reinforcing fibre (B) and the at least one blowing agent (C*), preferably based on the total weight of the polymer composition (PC).

It is particularly preferable when the polymer composition (PC) comprises in the range from 46 to 89.9% by weight of the at least one thermoplastic polymer (A), in the range from 10 to 50% by weight of the at least one reinforcing fibre (B) and in the range from 0.1 to 4% by weight of the at least one blowing agent (C*), in each case based on the sum of the weight percentages of the at least one thermoplastic polymer (A), the at least one reinforcing fibre (B) and the at least one blowing agent (C*), preferably based on the total weight of the polymer composition (PC).

It is most preferable when the polymer composition (PC) comprises in the range from 57 to 79.8% by weight of the at least one thermoplastic polymer (A), in the range from to 40% by weight of the at least one reinforcing fibre (B) and in the range from 0.2 to 3% by weight of the at least one blowing agent (C*), in each case based on the sum of the weight percentages of the at least one thermoplastic polymer (A), the at least one reinforcing fibre (B) and the at least one blowing agent (C*), preferably based on the total weight of the polymer composition (PC).

The present invention thus also provides a process for the production of a moulded article (MA) in which the polymer composition (PC) comprises in the range from 35 to 99.98% by weight of component (A), in the range from 0.01 to 60% by weight of component (B) and from 0.01 to 5% by weight of component (C*), based in each case on the total weight of the polymer composition (PC).

The polymer composition (PC) may further comprise at least one carbon black (D) in addition to the at least one thermoplastic polymer (A), the at least one reinforcing fibre (B) and the at least one blowing agent (C*).

The present invention thus also provides a process for the production of a moulded article (MA) in which the polymer composition (PC) further comprises at least one carbon black (D).

In case the polymer composition (PC) comprises at least one carbon black (D), the polymer composition (PC) comprises, for example, in the range from 0.01 to 5% by weight, preferably in the range from 0.1 to 4% by weight, most preferably in the range from 0.3 to 3% by weight, of the at least one carbon black (D), based on the total weight of the polymer composition (PC).

Furthermore, the polymer composition (PC) may also comprise at least one further additive (E) in addition to the at least one thermoplastic polymer (A), the at least one reinforcing fibre (B), the at least one blowing agent (C*) and optionally, the at least one carbon black (D).

The present invention thus also provides a process for the production of a moulded article (MA) in which the polymer composition (PC) comprises at least one further additive (E) selected from the group consisting of stabilizers, dyes, pigments, impact modifiers, flame retardants and plasticizers.

In case the polymer composition (PC) comprises at least one further additive (E), the polymer composition (PC) comprises, for example, in the range from 0.1 to 2% by weight, preferably in the range from 0.2 to 1.5% by weight, most preferably in the range from 0.5 to 1% by weight, of the at least one further additive (E), based on the total weight of the polymer composition (PC).

It will also be appreciated that when the polymer composition (PC) comprises at least one carbon black (D) and/or at least one further additive (E), the % by weight values of the at least one thermoplastic polymer (A) present in the polymer composition (PC) are correspondingly reduced so that the sum of the % by weight values of the at least one thermoplastic polymer (A), of the at least one reinforcing fibre (B) and of the at least one blowing agent (C*) sum to 100%.

To provide the flowable composition (FC), the temperature of the extruder during the step a) can be any temperature and is usually in the range from 200 to 350° C., preferably in the range from 220 to 330° C. and particularly preferably in the range from 240 to 310° C.

The barrel temperature of the extruder can be higher than the temperature of the components in the extruder, and it is equally possible that the barrel temperature of the extruder is lower than the temperature of the components in the extruder. By way of example, it is possible that the barrel temperature of the extruder is initially higher than the temperature of the components in the extruder when the components are being heated. When the components in the extruder are being cooled, it is possible that the barrel temperature of the extruder is lower than the temperature of the components in the extruder.

The temperatures given in the present invention and referring to the extruder are meant to be barrel temperatures of the extruder. “Barrel temperature of the extruder” means the temperature of the barrel of the extruder. The barrel temperature of the extruder is therefore the temperature of the external wall of the extruder barrel.

As extruder, any extruder known to the skilled person is suitable which can be used at the temperatures and pressures during the compounding. In general, the extruder can be heated to at least the temperature, at which the at least one thermoplastic polymer (A), the at least one reinforcing fibre (B), the at least one blowing gas (C) or the at least one blowing agent (C*), respectively, and, optionally, the at least one carbon black (D) and/or the at least one additive (E) are compounded.

The extruder may be a single-, twin- or multiple-screw extruder. Twin-screw extruders are preferred. Twin-screw extruders are also known as double-screw extruders. The twin-screw extruders may be co-rotating or counter-rotating. Single-screw extruders, twin-screw extruders and multiple-screw extruders are known to the skilled person and are for example described in C. Rauwendaal: Polymer extrusion, Carl Hanser Verlag GmbH & Co. KG, 5th edition (16 Jan. 2014).

The extruder may also comprise further devices, for example mixing elements or kneading elements.

Mixing elements serve for the mixing of the individual components comprised in the extruder. Suitable mixing elements are known to the skilled person and are, by way of example, static mixing elements or dynamic mixing elements.

Kneading elements likewise serve for the mixing of the individual components comprised in the extruder. Suitable kneading elements are known to the person skilled in the art and are, by way of example, kneading screws or kneading blocks, for example disk kneading blocks or shoulder kneading blocks. The components (A), (B), (C) or (C*), respectively, and optionally (D) and/or (E) can be added to the extruder in succession or concurrently and are mixed and compounded in the extruder to obtain the flowable composition (FC).

The at least one carbon black (D) can be introduced as powder or in the form of a masterbatch (MB) into the extruder. Preferably, the at least one carbon black (D) is introduced in the form of a masterbatch (MB) into the extruder.

The masterbatch (MB) comprises preferably the at least one thermoplastic polymer (A) and the at least one carbon black (D).

In a preferred embodiment, the at least one thermoplastic polymer (A), the at least one reinforcing fibre (B), the at least one blowing gas (C) or the at least one blowing agent (C*), respectively, the masterbatch (MB) and optionally the at least one further additive (E) are compounded in a twin-screw extruder, wherein the masterbatch (MB) comprises the at least one thermoplastic polymer (A) and the at least one carbon black (D).

Preferably, the masterbatch (MB) comprises from 60 to 80% by weight of component (A) and in the range from 20 to 40% by weight of component (D), more preferably from 60 to 75% by weight of component (A) and in the range from 25 to 40% by weight of component (D), most preferably from 65 to 75% by weight of component (A) and in the range from 25 to 35% by weight of component (D), based in each case on the total weight of the masterbatch (MB).

Preferably, the masterbatch (MB) is prepared by compounding the at least one thermoplastic polymer (A) and the at least one carbon black (D). For example, the at least one thermoplastic polymer (A) and the at least one carbon black (D) are compounded in an extruder and subsequently extruded therefrom, optionally with subsequent extrudate pelletization.

To prepare the masterbatch (MB), the temperature of the extruder during the compounding of the components (A) and (D) can also be any temperature and is usually in the range from 200 to 350° C., preferably in the range from 220 to 330° C. and particularly preferably in the range from 240 to 310° C.

In case the masterbatch (MB) is produced by subsequent extrudate pelletization, the pellets have an average particle size in the range from 0.5 to 10 mm, more preferably in the range from 0.8 to 5 mm and most preferably in the range from 1 to 3 mm, determined by microscopy.

### Injection of the Flowable Composition (FC) (Step b))

In step b), the flowable composition (FC) provided in step a) is injected into a mould at a first pressure (p₁).

The first pressure (p₁) is preferably in the range from 500 to 2500 bar, more preferably in the range from 1000 to 2000 bar, and, most preferably in the range from 1000 to 1800 bar, wherein the first pressure (p₁) is measured in the injection unit of the extruder.

The first pressure (p1) is also called filling pressure.

Thus, the present invention also provides a process for the production of a moulded article (MA) in which, in step b), the first pressure (p₁) is in the range from 500 to 2500 bar.

Preferably, the flowable composition (FC) provided in step a) is injected at a temperature in the range from 150 to 400° C., more preferably in the range from 200 to 350° C., most preferably in the range from 220 to 330° C., and, particularly preferably in the range from 240 to 310° C., into the mould.

Thus, the present invention also provides a process for the production of a moulded article (MA) in which, in step b), the flowable composition (FC) is injected at a temperature in the range from 150 to 400° C. into the mould.

The mould into which the flowable composition (FC) is injected in step b) has preferably a temperature T_{M} in the range of 20 to 120° C.

Thus, the present invention also provides a process for the production of a moulded article (MA) in which the mould into which the flowable composition (FC) is injected in step b) has a temperature T_{M} in the range from 20 to 120° C.

### Cooling of the Flowable Composition (FC) (Step c))

In step c), the flowable composition (FC) injected in step b) is cooled at a holding pressure (p₂), wherein the holding pressure (p₂) is lower than the first pressure (p₁), to obtain the moulded article (MA).

Preferably, the holding pressure (p₂) is in the range from 400 to 1500 bar, more preferably in the range from 600 to 1300 bar, and, most preferably in the range from 700 to 1200 bar. The holding pressure (p₂) is also measured in the injection unit of the extruder.

In a preferred embodiment of the present invention, the holding pressure (p₂) is adjusted, so that the internal pressure (pᵢ) measured within the cavity of the mould is preferably in the range from 300 to 700 bar.

Thus, the present invention also provides a process for the production of a moulded article (MA) in which, in step c), the holding pressure (p₂) is in the range from 400 to 1500 bar.

In step c), the moulded article (MA) is obtained.

The moulded article (MA) obtained in step c) preferably comprises less of the at least one blowing gas (C) than the flowable composition (FC) provided in step a), more preferably the moulded article (MA) obtained in step c) comprises in the range from 0 to 3% by volume of the at least one blowing gas (C), based on the total volume of the moulded article (MA), and, most preferably, 0 to 2% by volume of the at least one blowing gas (C), based on the total volume of the moulded article (MA), since, by applying the holding pressure (p₂), the at least one blowing gas (C) is compacted.

Thus, the present invention also provides a process for the production of a moulded article (MA) in which, the moulded article (MA) obtained in step c) comprises less of the at least one blowing gas (C) than the flowable composition (FC) provided in step a), preferably the moulded article (MA) obtained in step c) comprises in the range from 0 to 3% by volume of the at least one blowing gas (C), based on the total volume of the moulded article (MA).

The density (p2) of the moulded article (MA) is usually higher than the density (p1) of the flowable composition (FC), since, by applying the holding pressure (p₂), the density (p1) of the flowable composition (FC) is preferably reduced in the range from 10 to 20%.

The flowable composition (FC) can be cooled by any method known to the skilled person.

The flowable composition (FC) is preferably cooled to a temperature in the range from 20 to 160° C., more preferably to a temperature in the range from 60 to 100° C.

### Step d)

In step d), the moulded article (MA) is removed from the mould.

Thus, the present invention also provides a moulded article (MA) obtained by the inventive process.

Preferably, the parallel shrinkage (the shrinkage in longitudinal direction) of the inventive moulded article (MA) is at least 20%, more preferably at least 30%, most preferably at least 50%, increased compared to the shrinkage of moulded articles of the prior art, wherein the shrinkage was determined according to ISO 294.

The warpage of the inventive moulded article (MA) is therefore preferably at least 20%, more preferably at least 30%, reduced compared to the shrinkage of moulded articles of the prior art.

The invention is elucidated in detail by examples hereinafter, without restricting it thereto.

### EXAMPLES

The following components were employed:

### Thermoplastic Polymer (A):

(A1) Polyamide 6 (PA 6) (Ultramid® B27E; BASF SE)

### Reinforcing Fibre (B):

(B1) Glass Fibre (ECS 03 T-249H; Nippon Electric Glass)

### Blowing Agent (C):

(C1) Styrene-maleic-anhydride-copolymer (SMA® 3000; Cray Valley)

### Carbon Black (D):

(D1) Ensaco® 250G (Imerys Graphite & Carbon Switzerland Ltd.)

### Additives (E):

(E1) N,N′-Ethylenebis(stearamide)
(E2) Masterbatch comprising CuI and KI

Table 1 states the essential parameters of the thermoplastic polymer used (component (A)).

TABLE 1

| | | | | | | Zero shear rate |
|---|---|---|---|---|---|---|
| | | AEG | CEG | T_{M} | T_{G} | viscosity η₀ at |
| | Type | [mmol/kg] | [mmol/kg] | [° C.] | [° C.] | 240° C. [Pas] |
| (A1) | PA 6 | 36 | 54 | 220.0 | 53 | 399 |

AEG indicates the amino end group concentration. This is determined by means of titration. For determination of the amino end group concentration (AEG), 1 g of the component (thermoplastic polymer) was dissolved in 30 mL of a phenol/methanol mixture (volume ratio of phenol:methanol 75:25) and then subjected to potentiometric titration with 0.2 N hydrochloric acid in water.

The CEG indicates the carboxyl end group concentration. This is determined by means of titration. For determination of the carboxyl end group concentration (CEG), 1 g of the component (thermoplastic polymer) was dissolved in 30 mL of benzyl alcohol. This was followed by visual titration at 120° C. with 0.05 N potassium hydroxide solution in water.

The melting temperature (T_{M}) of the thermoplastic polymer and the glass transition temperature (T_{G}) were each determined by means of differential scanning calorimetry.

For determination of the melting temperature (T_{M}), a first heating run (H1) at a heating rate of 20 K/min was measured. The melting temperature (T_{M}) then corresponded to the temperature at the maximum of the melting peak of the heating run (H1).

For determination of the glass transition temperature (T_{G}), after the first heating run (H1), a cooling run (C1) and subsequently a second heating run (H2) were measured. The cooling run was measured at a cooling rate of 20 K/min; the first heating run (H1) and the second heating run (H2) were measured at a heating rate of 20 K/min. The glass transition temperature (T_{G}) was then determined at half the step height of the second heating run (H2).

The zero shear rate viscosity η₀ was determined with a “DHR-1” rotary viscometer from TA Instruments and a plate-plate geometry with a diameter of 25 mm and a plate separation of 1 mm. Unequilibrated samples were dried at 80° C. under reduced pressure for 7 days and these were then analysed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

### Production of a Carbon Black Masterbatch (MB1)

The components reported in table 2 were compounded in the ratio reported in table 2 in a twin-screw extruder (ZE25A UXTI) at 280 rpm, a barrel temperature of 260° C. and a throughput of 11.2 kg/h with subsequent extrudate pelletization.

TABLE 2

| Example | (A1) [wt %] | (D1) [wt %] |
|---|---|---|
| (MB1) | 70 | 30 |

### Provision of the Flowable Composition (FC)

The components reported in table 3 were compounded in the ratio reported in table 3 in a twin-screw extruder (ZE25A UXTI) at 280 rpm, a barrel temperature of 260° C. and a throughput of 11.2 kg/h.

TABLE 3

| Example | E1 | E2 | C3 |
|---|---|---|---|
| (A1) [wt %] | 61.34 | 61.34 | 62.34 |
| (B1) [wt %] | 35 | 35 | 35 |
| (C1) [wt %] | 1 | 1 | — |
| (MB1) [wt %] | 1.67 | 1.67 | 1.67 |
| (E1) [wt %] | 0.3 | 0.3 | 0.3 |
| (E2) [wt %] | 0.69 | 0.69 | 0.69 |

### Production of Moulded Parts

The above provided flowable composition (FC) is then injection-moulded on an injection moulding machine to give moulded parts of a thickness of 2 mm, and of dimensions of 60×60 mm. The melt temperature in the inventive example E1 as well as in the comparative example C3 was 300° C. at 280 rpm, and in the inventive example E2 280° C. at 180 rpm. The flowable composition (FC) is injected at a first pressure (p₁). The flowable composition is then cooled at a holding pressure (p₂) to obtain the moulded article (MA), and the moulded article (MA) is removed from the mould. The first pressure (p₁) and the holding pressure (p₂) for the inventive examples E1 and E2, as well as for the comparative example C3, are listed in table 4.

TABLE 4

| Example | E1 | E2 | C3 |
|---|---|---|---|
| first pressure (p₁) [bar] | 1300 | 1329 | 697 |
| holding pressure (p₂) [bar] | 938 | 940 | 632 |

Subsequently, the properties of the moulded parts obtained were determined. The moulded parts obtained were tested in the dry state after drying at 80° C. for 336 h under reduced pressure. The results are shown in table 5. In addition, Charpy specimen were produced, which were likewise tested under dry conditions (according to ISO179-2/1eU: 1997+Amd.1:2011).

Tensile strength, tensile modulus of elasticity and elongation at break were determined according to ISO 527-1:2012.

The shrinkage was determined according to ISO 294.

TABLE 5

| Example | E1 | E2 | C3 |
|---|---|---|---|
| Parallel Shrinkage [%] | 0.61 | 0.72 | 0.27 |
| Perpendicular Shrinkage [%] | 1.02 | 1.07 | 0.88 |
| Perpendicular Shrinkage/ | <2 | <1.5 | >3 |
| Parallel Shrinkage | | | |
| Tensile modulus of | | 11400 | 11090 |
| elasticity [MPa] | | | |
| Tensile strength [MPa] | | 170 | 177 |
| Elongation at break [%] | | 3.9 | 3.0 |
| Charpy impact resistance, | | 98 | 82 |
| unnotched [kJ/m²] | | | |

It is clearly apparent from table 5 that by the use of the at least one blowing gas (C) in the production of the moulded article (MA), wherein the moulded article (MA) comprises at least one thermoplastic polymer (A) and at least one reinforcing fibre (B), especially the parallel shrinkage of the moulded article (MA) is increased and, therefore, a reduced warpage of the moulded article (MA) is achieved. The moulded articles also show, despite the high shrinkage, good mechanical properties like a high tensile modulus of elasticity and a high tensile strength.

1. A process for the production of a moulded article (MA) comprising the following steps a) to d) of
a) providing a flowable composition (FC) comprising at least the following components (A) to (C)
(A) at least one thermoplastic polymer,
(B) at least one reinforcing fibre and
(C) at least one blowing gas,
b) injecting the flowable composition (FC) provided in step a) into a mould at a first pressure (p₁),
c) cooling the flowable composition (FC) injected in step b) at a holding pressure (p₂), wherein the holding pressure (p₂) is lower than the first pressure (p₁), to obtain the moulded article (MA), and
d) removing the moulded article (MA) from the mould,
wherein the at least one thermoplastic polymer (A) is selected from the group consisting of polyamide 6 (PA 6), polyamide 66 (PA 66), polyamide 6/66 (PA 6/66), polyamide 66/6 (PA 66/6), polyamide 610 (PA 610), polyamide 6/6T (PA 6/6T), polyamide 6T/6I (PA 6T/6I), polyamide 12 (PA12), polyamide 4T (PA 4T), polyamide 9T (PA 9T), polyamide 46 (PA 46), polyamide 1010 (PA1010) and polyamide 1212 (PA1212),
wherein, in step b), the first pressure (p1) is in the range from 1000 to 2000 bar, and, in step c), the holding pressure (p2) is in the range from 600 to 1300 bar.

2. The process according to claim 1, wherein the moulded article (MA) obtained in step c) comprises less of the at least one blowing gas (C) than the flowable composition (FC) provided in step a).

3. The process according to claim 1, wherein, in step b), the flowable composition (FC) is injected at a temperature in the range from 150 to 400° C. into the mould.

4. The process according to claim 1, wherein the mould into which the flowable composition (FC) is injected in step b) has a temperature T_{M} in the range from 20 to 120° C.

5. The process according to claim 1, wherein the at least one thermoplastic polymer (A) is selected from the group consisting of polyamides, polyesters, polycarbonates, polyolefins, polyurethanes, polyethers, polysulfones, polymethacrylates, polystyrenes and polyoxymethylene.

6. The process according to claim 1, wherein the at least one reinforcing fibre (B) is selected from the group consisting of natural fibres, basalt fibres, aramid fibres, glass fibres and carbon fibres.

7. The process according to claim 1, wherein the at least one reinforcing fibre (B) is selected from the group consisting of glass fibres, wherein the ratio of the length of the glass fibres to the diameter of the glass fibres is in the range from 20:1 to 30:1.

8. The process according to claim 1, wherein the at least one blowing gas (C) is selected from the group consisting of nitrogen, carbon dioxide and carbon monoxide.

9. The process according to claim 1, wherein, in step a), the flowable composition (FC) comprises in the range from 0.01 to 10% by volume of the at least one blowing gas (C), based on the total volume of the flowable composition (FC).

10. The process according to claim 1, wherein the flowable composition (FC) is provided by compounding a polymer composition (PC) comprising at least the following components (A), (B) and (C*)
(A) at least one thermoplastic polymer,
(B) at least one reinforcing fibre and
(C*) at least one blowing agent,
in an extruder, wherein the at least one blowing agent (C*) is decomposed to obtain the at least one blowing gas (C), to obtain the flowable composition (FC) comprising at least the components (A) to (C).

11. The process according to claim 10, wherein the at least one blowing agent (C*) is selected from the group consisting of gas-releasing polymers, gas-releasing additives and mixtures therefrom.

12. The process according to claim 10, wherein the polymer composition (PC) comprises in the range from 35 to 99.98% by weight of component (A), in the range from 0.01 to 60% by weight of component (B) and from 0.01 to 5% by weight of component (C*), based in each case on the total weight of the polymer composition (PC).

13. The process according to claim 1, wherein the flowable composition (FC) further comprises at least one carbon black (D).

14. The process according to claim 1, wherein the flowable composition (FC) comprises at least one further additive (E) selected from the group consisting of stabilizers, dyes, pigments, impact modifiers, flame retardants and plasticizers.

15. A method of using at least one blowing gas (C) in the process for the production of a moulded article (MA) according to claim 1, the method comprising using the at least one blowing gas (C) for reducing the warpage of the moulded article (MA), wherein the moulded article (MA) comprises at least one thermoplastic polymer (A) and at least one reinforcing fibre (B).

16. A moulded article (MA) obtained by a process according to claim 1.

17. (canceled)

18. (canceled)

19. (canceled)

20. The process according to claim 1, wherein the moulded article (MA) obtained in step c) comprises in the range from 0 to 3% by volume of the at least one blowing gas (C), based on the total volume of the moulded article (MA).
